(19) United States
(12) Patent Application Publication
(10) Pub. No.: US 2004/0103153 A1
(43) Pub. Date: May 27, 2004

(54) Apparatus and method for providing smart network appliances

(76) Inventors: Tsung-Yen Dean Chang, Los Altos Hills, CA (US); Bo Xiong, Fremont, CA (US); Chuang Li, Saratoga, CA (US)

Correspondence Address: FISH & NEAVE, 1251 AVENUE OF THE AMERICAS, 50TH FLOOR, NEW YORK, NY, 10020-1105, US

(21) Appl. No.: 10/303,323

(22) Filed: Nov. 21, 2002

(51) Int. Cl. G06F 15/16

(52) U.S. Cl. 709/206

(57) ABSTRACT

An apparatus and method for real-time monitoring and controlling of network or network appliance activity through use of instant messaging software on a smart network appliance are provided. Network and network appliance activity are monitored by a smart network appliance and communicated to a user, server, or other network appliance via instant messaging. The smart network appliance acts as an instant messaging client, with its own screen name and buddy list. A command set is provided in the smart network appliance to enable the buddies in the buddy list to order the smart network appliance to perform an action by sending an instant message to the smart network appliance, the instant message including a command from the command set.

### FIELD OF THE INVENTION

This invention relates generally to smart network appliances. More specifically, the present invention provides an apparatus and method for real-time monitoring and controlling of network or network appliance activity through use of instant messaging software on a network appliance.

### BACKGROUND OF THE INVENTION

The popularity of the Internet has grown rapidly over the past several years. A decade ago, the Internet was limited to the academic and research community. Today, the Internet has grown into a communications network that reaches millions of people around the world. It provides a powerful and versatile environment for business, education, and entertainment. At any given time, massive amounts of digital information are accessed and exchanged on the Internet by millions of users worldwide with many diverse backgrounds and personalities, including children, students, educators, business men and women, and government officials, among others.

Users may access the Internet through a dial-up modem connected to existing telephone lines, or through high-speed connections such as a direct connection to the Internet backbone or connections provided by T1 or T3 lines leased from telephone companies, cable modems, or DSL modems. These high-speed connections may be shared by multiple users on a local area network (“LAN”) through the use of a router, which is a device that handles all the digital information traffic between the Internet and each one of the users in the LAN.

The digital information may be accessed and exchanged through the World Wide Web (hereinafter “the web”), or by using electronic mail, file transfer protocols, or a variety of other applications, including peer-to-peer (“P2P”) file sharing systems and Instant Messaging (“IM”). Information on the web is typically viewed through a “web browser” such as Internet Explorer, available from Microsoft Corporation, of Redmond, Wash. The web browser displays multimedia compositions called “web pages” that contain text, audio, graphics, imagery and video content, as well as nearly any other type of content that may be experienced through a computer or other network appliances equipped with a web browser. A network appliance is an electronic device configured with a network access system for connecting to a network and sharing resources and information with other network appliances on the network, such as personal and portable computers, electronic organizers, personal digital assistants (“PDAs”), and wireless telephones.

Besides the web, P2P file sharing systems and IM have become increasingly popular vehicles for exchanging digital information. P2P file sharing systems enable users to connect to each other and directly access files from one another's network appliances. Such systems are mostly used for exchanging digital music or image files on the Internet. Examples include the open source systems Gnutella and Napigator.

In addition to digital files, users may also exchange messages with one another by using an IM service. An IM service is primarily used by a subscriber to “chat” with one or more other IM subscribers. Because the exchange of information is almost instantaneous, IM is quicker than ordinary electronic mail and a more effective way to communicate with other users.

To access an IM service, a user registers with an IM service provider to become a subscriber, and, after downloading and installing IM client software, connects to the Internet (or other appropriate data network), and enters a selected username and password to log in to an IM server maintained by the IM service provider. The IM server maintains a contact list or “buddy list” for each subscriber to allow the subscriber to send an instant message to any one in his/her buddy list, as long as that person, commonly referred to as a “buddy”, is also online. The username is often referred to as a “screen name”, to reflect the subscriber's virtual identity and presence while online. In addition, a subscriber may enter a “chat room” to communicate to any subscriber in the room.

Once a subscriber has logged in to the IM server, his/her presence on the network is made known to all of his/her buddies on his/her buddy list. The subscriber can then engage in conversations with his/her buddies and update his/her buddy list to include other subscribers that they desire to communicate with.

Because of ease of use and convenient buddy lists, IM has become especially popular among children, teens, and business, educational and governmental users who rely on IM as a communication means. Popular IM applications include the freely-distributed ICQ, AOL Instant Messenger (“AIM”), provided by America Online, Inc., of Dulles, Va., Yahoo! Messenger, provided by Yahoo!, Inc., of Sunnyvale, Calif., and MSN Messenger, provided by Microsoft Corporation, of Redmond, Wash.

With the ease of access and distribution of digital information over the Internet, it has become increasingly desirable to provide smart network appliances in the home and other environments that can distribute and act upon digital information exchanged in a network. In particular, it has become desirable to enable a network appliance to communicate status information regarding its functionality or the functionality of the network or other network appliances in the network with a user. Additionally, it has become desirable to enable a user to monitor and control the status of other network appliances in the network.

Smart network appliances are network appliances capable of announcing their presence and status to users of other smart network appliances or to other smart network appliances themselves and responding to commands from the users or from the other smart network appliances. Efforts to provide smart network appliances have focused on the development of network appliances that can monitor and control the status of a local area network or smart household appliances designed for use in a networked household.

In the first case, the smart network appliances include network gateways or routers equipped with network management software to monitor and control local area network activity. For example, the RP614 router, provided by NETGEAR, Inc., of Santa Clara, Calif., may be configured to provide reports of online activity for every network appliance in a local area network and also limit access to predetermined web sites or to the web. The RP614 router maintains a log of web sites visited by all users in the local area network and may send e-mail alerts to a controlling user if another user attempts to access a restricted web site.

However, the RP614 router does not necessarily provide real-time monitoring functionality and its ability to control network activity of the network appliances is limited to controlling user access to predetermined web sites. Additionally, a user must log on to the router in order to obtain activity reports, and therefore is required to know the IP address of the router in advance. If the IP address of the router changes dynamically, the user may not be able to find the IP address of the router to remotely monitor network activity from a network appliance outside the local area network.

In another example, the Symantec Gateway Security, a network gateway provided by Symantec Corporation, of Cupertino, Calif., has embedded firewall, intrusion detection, and content filtering software for controlling the Internet access of the network appliances connected to it. A controlling user can connect to the Symantec Gateway Security and specify rules and parameters for controlling the Internet access of all network appliances in the local area network supported by the gateway. The rules and parameters direct the network gateway to automatically perform an action on a network appliance connected to it in response to monitored network activity without requiring human intervention.

While the Symantec Gateway Security may act upon network activity in real-time based on pre-determined rules, it is not able to communicate network activity to a controlling user and respond to commands from the controlling user in real-time. That is, the Symantec Gateway Security is not able to receive new access control rules from a controlling user and act upon network activity based on the newly received rules in real-time.

In addition to smart network appliances that monitor and control local area network activity, smart network appliances designed for use in a networked household have recently been developed. These appliances are typical household appliances equipped with Internet access capabilities, such as the Internet enabled microwave, washing machine, air-conditioner, and refrigerator provided by LG Electronics, Inc., of Seoul, South Korea.

Users may download recipes from the Internet and store them on the microwave's LCD display, turn on the washing machine or monitor its wash cycle, control the temperature of their home and turn on/off the air conditioner from a dedicated web site, or use a screen on the refrigerator to view e-mail, download digital music, watch television, leave video messages for family members and keep track of dates and appointments. Users may also remotely maintain an inventory of groceries in the refrigerator or download recipes to it. The refrigerator also has a server that enables it to control the communications to the microwave, washing machine, and air-conditioner.

While these and other currently available smart network appliances for the home are promising to revolutionize many household chores, they are still very expensive, complex, and difficult to maintain. Users are required to connect to dedicated web sites or install other software on every network appliance they desire to use to control the smart network appliances in their home. Furthermore, users may not monitor the status of these appliances nor receive messages from these appliances regarding their status in real-time. Users are also not able to direct these appliances to control other appliances in the household in real-time by sending real-time commands to the appliances.

In view of the foregoing, it would be desirable to provide systems and methods for real-time monitoring and control of network appliances and network activity.

It further would be desirable to provide systems and methods for a network appliance to monitor its status and the status of the network and communicate monitoring information to a controlling user in real-time.

It also would be desirable to provide systems and methods for a network appliance to monitor its status and the status of the network and control access to it and the network based on its monitoring.

It also would be desirable to provide systems and methods for a network appliance to monitor its status and the status of local area network activity, communicate monitoring information to a controlling user and respond to commands from the controlling user to perform a task or to control access to the network activity.

### SUMMARY OF THE INVENTION

In view of the foregoing, it is an object of the present invention to provide systems and methods for real-time monitoring and control of network appliances and network activity.

It is a further object of the present invention to provide systems and methods for a network appliance to monitor its status and the status of the network and communicate monitoring information to a controlling user in real-time.

It is also an object of the present invention to provide systems and methods for a network appliance to monitor its status and the status of the network and control access to it and the network based on its monitoring.

It is also an object of the present invention to provide systems and methods for a network appliance to monitor its status and the status of local area network activity, communicate monitoring information to a controlling user and respond to commands from the controlling user to perform a task or to control access to the network activity.

These and other objects of the present invention are accomplished by providing a smart network appliance configured so that it can act and communicate as an IM client without user intervention. The smart network appliance is an electronic device configured with a network access system for connecting to a network and sharing resources and information with other network appliances on the network, such as personal and portable computers, electronic organizers, personal digital assistants (“PDAs”), wireless telephones, entertainment systems, stereo systems, video game units, household appliances, and other embedded electronic devices, among others. The smart network appliance may include a network gateway, a router, modem, hub, switch, or other device that acts as an entrance to another network.

The smart network appliance of the present invention has embedded IM capability that enables it to announce its presence and status to users of other network appliances or to other smart network appliances themselves via IM and responding to commands from the users or from the other smart network appliances. The commands may be used to monitor network activity in case the smart network appliance includes a network gateway or to control the operation of the smart network appliance itself or of another network appliance connected to the smart network appliance.

The smart network appliance of the present invention connects to an IM server as an IM client, with its own screen name and password assigned upon configuration. The IM client is a standard IM client for sending/receiving instant messages to/from another IM client connected to the IM server. The IM server is a standard IM server for supporting an IM service. Standard IM clients and servers include the freely-distributed ICQ, AOL Instant Messenger (“AIM”), provided by America Online, Inc., of Dulles, Va., Yahoo! Messenger, provided by Yahoo!, Inc., of Sunnyvale, Calif., and MSN Messenger, provided by Microsoft Corporation, of Redmond, Wash., or other IM software developed to provide instant messaging capabilities to users.

The smart network appliance may be configured to have one or more controlling users as its buddies, including an individual with access to a network appliance with an IM client, a server with an IM client, or another smart network appliance configured with an IM client and able to send/receive instant messages to/from other smart network appliances, servers, or individuals without user intervention.

The controlling users may monitor and control activity of the smart network appliance or of other network appliances connected to the smart network appliance without having to directly log into the smart network appliance or install software on other network appliances in the network. By acting as an IM buddy to the controlling users, the smart network appliance may send instant messages to the controlling users to report activity to them in real-time. Controlling users may then use a command from a command set provided in the smart network appliance to send instant messages to it. The commands in the command set direct the smart network appliance to perform an action as a result of its monitoring. For example, a controlling user may direct the smart network appliance to turn one of its functions on or off, or in case the smart network appliance includes a network gateway in a local area network, block a user in the local area network from accessing a web site by sending an instant message to the smart network appliance with a “block” command and the URL to be blocked. The commands may also be used to monitor and control the operation of another network appliance connected to the smart network appliance or to monitor and control the operation of network appliances in a local area network having the smart network appliance as its gateway.

In a preferred embodiment, the system and method of the present invention involve six main components embedded in the smart network appliance: (1) an IM access engine; (2) an IM client module; (3) a monitoring engine; (4) an IM command set; (5) an IM command set interpreter; and (6) a reporting engine.

The IM access engine launches the IM client module to connect to an IM server. Once the IM client is connected to the IM server, the IM access engine logs the smart network appliance onto the IM server with its own screen name and password specified upon the smart network appliance's configuration. The screen name and password may be changed at any time and, preferably, are known only to the controlling users authorized to communicate to the smart network appliance via IM.

By launching an IM client, the smart network appliance can send instant messages to any controlling user on its buddy list. The controlling users may be using the same IM client as the smart network appliance, that is, the controlling users and the smart network appliance may be buddies in the same IM service network, or they may be using different IM clients, in which case the smart network appliance may have an IM client for each IM service used by its buddies, or it may have a single universal IM client and/or an IM plug-in that enables the smart network appliance to connect to multiple IM services.

Once the smart network appliance is logged onto an IM server, the IM server sends connection information of each controlling user in the smart network appliance's buddy list to the smart network appliance. If the IM server finds any of the smart network appliance's buddies logged onto the IM server, the IM client in the smart network appliance is notified so the smart network appliance may send messages to its buddies who are logged onto the IM server. The messages sent by the smart network appliance may contain information detailing its activity, or in case the smart network appliance includes a network gateway to a local area network, the activity of each user in the local area network, such as web sites visited, chat rooms entered and the contents of the messages exchanged in the chat rooms, image files viewed, and so on. The smart network appliance may also use its IM client to find dynamic IP addresses of other smart network appliances on the fly, without requiring user intervention.

The smart network appliance may include a monitoring engine, which is a program capable of collecting status information regarding the operation of the smart network appliance or of other network appliances connected to it and information regarding the activity of a local area network in case the smart network appliance includes a network gateway to the local area network. The monitoring engine may include a packet sniffer for reading the contents of each network packet transmitted from or to the network through the smart network appliance.

The information collected by the monitoring engine is transmitted by the smart network appliance to each one of its buddies that are online using the IM client. The IM client in the smart network appliance may send the information to the IM clients of the smart network appliance's buddies directly, without having to communicate to the IM server, or indirectly, by first sending the information to the IM server, which subsequently forwards the information to the appropriate IM clients of the smart network appliance's buddies.

After receiving a message from the smart network appliance, a controlling user may direct the smart network appliance to perform an action based on the information collected by the monitoring engine and transmitted to the controlling user, such as turning one of its functions on or off, or in case the smart network appliance includes a network gateway, blocking a user from visiting a given web site, entering a particular chat room, limiting the time a user may stay online, and so on. The controlling user directs the smart network appliance to perform an action by using a command in an IM command set embedded in the smart network appliance.

The IM command set is a list of commands that a controlling user may use to direct the smart network appliance to perform an action, such as a “turn off” command to turn off an operation of the smart network appliance or an operation of another network appliance connected to the smart network appliance, or in case the smart network appliance includes a network gateway to a local area network, a “block” command to block a user from visiting a web site or chat room, a “disconnect” command to disconnect a user from the network, and a “time out” command to limit the time a user is connected to the network, among others. An IM command set interpreter is provided in the smart network appliance for it to understand each message received through its IM client and execute the command included in the message.

The smart network appliance also includes a reporting engine for recording activity of the smart network appliance or of other network appliances connected to it into logs and sending the logs to a controlling user. The logs may be transmitted to the controlling users via IM when the controlling users are online, posted on a secure web site accessed only by the controlling user with a security key, or transmitted by other means, such as via electronic mail, voice mail, among others.

Advantageously, the system and method of the present invention enable a smart network appliance to monitor its status, the status of other network appliances connected to it, and the status of local area network activity, communicate monitoring information to a controlling user and respond to commands from the controlling user to perform a task or to control access to the network activity. In addition, the system and method of the present invention enable a controlling user to access and act upon previously recorded network appliance or network activity using IM.

### BRIEF DESCRIPTION OF THE DRAWINGS

The foregoing and other objects of the present invention will be apparent upon consideration of the following detailed description, taken in conjunction with the accompanying drawings, in which like reference characters refer to like parts throughout, and in which:

FIG. 1 is a schematic diagram of an exemplary embodiment of the network environment in which the present invention operates;

FIG. 2 is a schematic diagram of another exemplary embodiment of the network environment in which the present invention operates;

FIG. 3 is a schematic diagram of yet another exemplary embodiment of the network environment in which the present invention operates;

FIG. 4 is a schematic diagram of the components used in a preferred embodiment of the present invention;

FIG. 5 is an illustrative diagram of a list of commands in the command set;

FIG. 6 is a flow chart for configuring a smart network appliance to act as an IM client;

FIG. 7 is a flow chart for monitoring network activity and communicating the monitored activity to a controlling user; and

FIG. 8 is a flow chart for performing an action based on monitored network information.

### DETAILED DESCRIPTION OF THE DRAWINGS

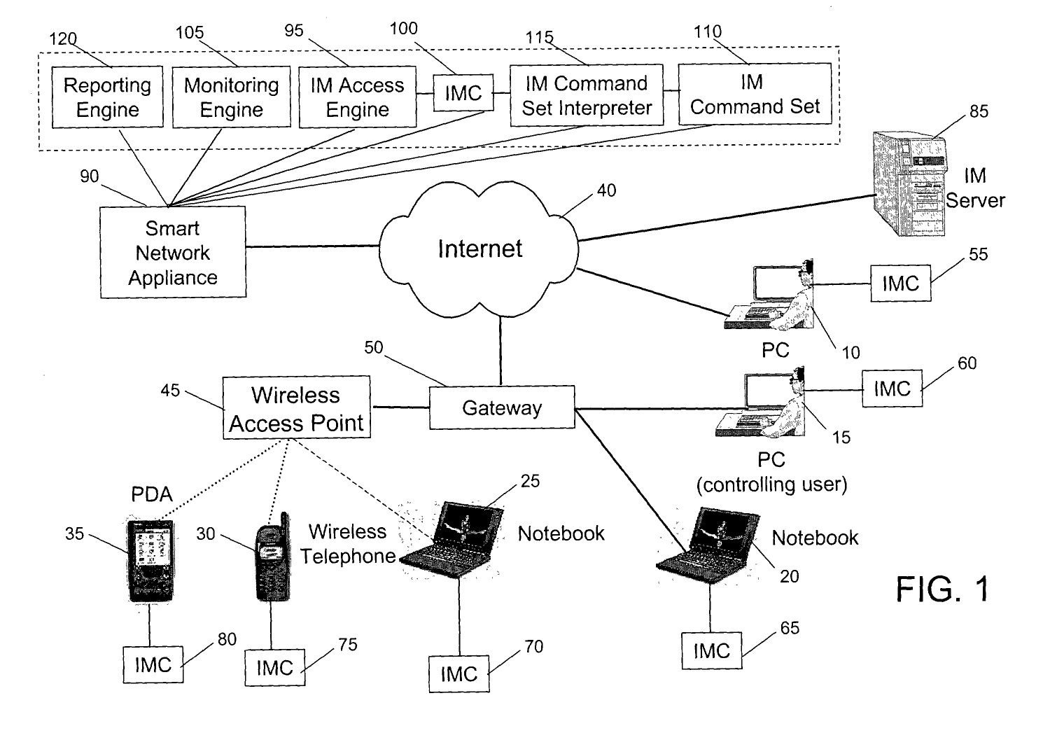

Referring now to FIG. 1, a schematic diagram of an exemplary embodiment of the network environment in which the present invention operates is described. Network appliances 15-35 form a local area network that connects to Internet 40 through network gateway 50. Internet appliances 15-20 connect to gateway 50 through a wired connection, while Internet appliances 25-35 connect to gateway 50 by means of a wireless connection through wireless access point 45. Internet appliance 10 connects to Internet 40 directly.

Network gateway 50 is a device that acts as an entrance to another network, such as a router, a modem, switch, hub, bridge, or other device. Network gateway 50 may also include a combination of network entrance devices, such as a router and a high-speed modem, including a DSL modem and a cable modem, among others. The router may be a stand-alone device or integrated into the high-speed modem.

Internet appliances 10-35 are equipped with instant messaging clients (“IMCs”) 55-80 for their users to send instant messages to other users, chat with other users in chat rooms, share links to web sites or multimedia files with other users, talk to other users through Internet 40 instead of a phone line, and receive real-time streamed content such as stock quotes. IMCs 55-80 connect to instant messaging server 85 (“IMS”) maintained by an IM service provider. Users of IMCs 55-80 connected to appliances 10-35 subscribe to an IM service maintained by the IM service provider. Each user of appliance 10-35 has a unique screen name and password for identifying the user as a subscriber when logging onto IMS 85. IMS 85 maintains a contact list or “buddy list” for each subscriber to allow the subscriber to send an instant message to any one in his/her buddy list, as long as that subscriber, commonly referred to as a “buddy”, is also online. In addition, a subscriber may enter a “chat room” to communicate to any subscriber in the room.

Once a subscriber has logged in to IMS 85, his/her presence on Internet 40 is made known to all of his/her buddies on his/her buddy list. The subscriber can then engage in conversations with his/her buddies and update his/her buddy list to include other subscribers that they desire to communicate with. The communication between two buddies may be directly between their IMCs 55-80, without involving IMS 85, or it may be between their IMCs 55-80 using IMS 85 as an intermediary. In the first case, IMS 85 is only involved in the communications between two subscribers during log-in or when a subscriber disconnects from IMS 85 or Internet 40. Examples of an IM service having IMCs 55-80 and IMS 60 include the freely-distributed ICQ, AOL Instant Messenger (“AIM”), provided by America Online, Inc., of Dulles, Va., Yahoo! Messenger, provided by Yahoo!, Inc., of Sunnyvale, Calif., and MSN Messenger, provided by Microsoft Corporation, of Redmond, Wash.

Smart network appliance (“SNA”) 90 is an electronic device configured with a network access system for connecting to Internet 40 and sharing resources and information with network appliances 10-35. SNA 90 may be a personal or portable computer, an electronic organizer, a PDA, a wireless telephone, an entertainment system, a stereo system, a video game unit, a household appliance, or an embedded electronic device, among others. SNA 90 may include a network gateway, a router, modem, hub, switch, or other device that acts as an entrance to another network, such as gateway 50. SNA 90 may have a web server, with associated web pages for configuring SNA 90.

Controlling user of appliance 15 monitors and controls SNA 90 by using IMC 60. SNA 90 has IMC access engine 95 for launching IMC 100 to connect to IMS 85 as a subscriber, with its own screen name and password specified upon configuration of SNA 90. IMC 100 is a standard IM client for sending/receiving instant messages to/from another IMC connected to IMS 85, such as IMCs 55-80. The screen name and password may be changed at any time and, preferably, are known only to the controlling users authorized to communicate to SNA 90 using IM. A controlling user may also specify SNA 90's buddy list upon configuration. SNA 90 connects to IMS 85 when it is powered up, and remains connected to IMS 85 as long as it is operating. In case SNA 90 fails, its connection to IMS 85 is lost momentarily until SNA 90 is reconnected to Internet 40.

It should be understood by one skilled in the art that there may be more than one controlling user controlling SNA 90 and the controlling user(s) may control SNA 90 from any one of appliances 10-35 or other appliances connected to Internet 40. It should also be understood by one skilled in the art that SNA 90's buddy list may include one or more controlling users. A controlling user may be an individual with access to a network appliance with an IM client, a server with an IM client, or another smart network appliance configured with an IM client and able to send/receive instant messages to/from other smart network appliances or individuals without user intervention.

SNA 90 has monitoring engine 105 to collect status information regarding the operation of SNA 90. After receiving a message from SNA 90, a controlling user may direct SNA 90 to perform an action, such as turning one of its functions on/off. The controlling user directs SNA 90 to perform an action by using a command in IM command set 110 embedded in SNA 90.

IM command set 110 has a list of commands that a controlling user may use to direct SNA 90 to perform an action, such as a “turn off” command to turn off an operation of SNA 90 or a network appliance connected to SNA 90, and a “time out” command to time out an activity of SNA 90. It should be understood by one skilled in the art that the commands included in IM command set 110 may be listed on web pages associated to a web server included in SNA 90 or a web site associated with the manufacturer of SNA 90, accessed through a graphical user interface on the appliance used by the controlling user to control SNA 90, accessed by a telephone line, or available through any other means, such as a hardcopy of commands as part of a manual or operating instructions associated to SNA 90.

IM command set interpreter 115 is provided in SNA 90 for it to understand each message received through IMC 100 and execute the command included in the message. SNA 90 also includes reporting engine 120 for recording activity information into logs and sending the logs to a controlling user. The logs may be transmitted to the controlling user via IM when the controlling user is online, posted on a secure web site accessed only by the controlling user with a security key, or transmitted by other means, such as via electronic mail, voice mail, among others.

It should be understood by one skilled in the art that appliances 10-35 are shown for the purposes of illustration only and other appliances may be connected to Internet 40. It should also be understood by one skilled in the art that IMCs 55-80 may be the same as IMC 100, that is, the users and SNA 90 may be buddies in the same IM service network, or they may be using different IMCs, in which case SNA 90 may have an IMC for each IM service used by its buddies, or it may have a single universal IMC and/or an IM plug-in that enables SNA 90 to connect to multiple IM services.

Additionally, it should also be understood by one skilled in the art that SNA 90 may have a server as its buddy to act as intermediary between SNA 90 and controlling users authorized to monitor and control SNA 90. The server may forward the instant messages sent by SNA 90 to the controlling users using any communication means, such as IM, electronic mail, or telephone, among others, or by posting the instant messages on a web site accessed by the controlling users.

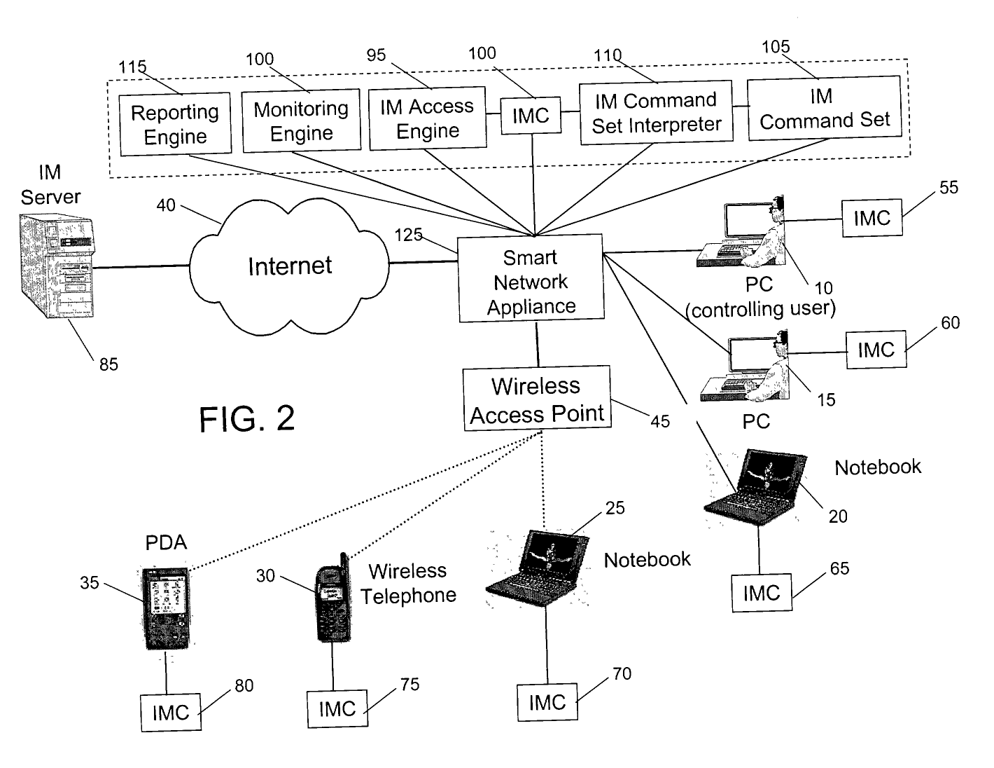

Referring now to FIG. 2, a schematic diagram of another exemplary embodiment of the network environment in which the present invention operates is described. In this embodiment, SNA 125 includes a network gateway to act as an entrance to Internet 40 for appliances 10-35, which form a local area network supported by SNA 125. A controlling user uses an IMC, such as IMC 55, to communicate with SNA 125 for the purposes of monitoring and controlling local area network activity of users of appliances 10-35. The controlling user may be using one of appliances 10-35 or any other appliance in the local area network or outside of it that has an IMC and lists SNA 125 as its buddy. For example, a controlling user may be using appliance 10 to monitor the network activity of his children using other appliances in the local area network.

The controlling user may direct SNA 125 to perform an action or to control the network activity of appliances 10-35 by using one of the commands in IM command set 110. For example, the controlling user may use a “block” command to block a user on the local area network supported by the network gateway in SNA 125 from visiting a web site or chat room, a “disconnect” command to disconnect a user from Internet 40, and a “time out” command to limit the time a user is connected to Internet 40.

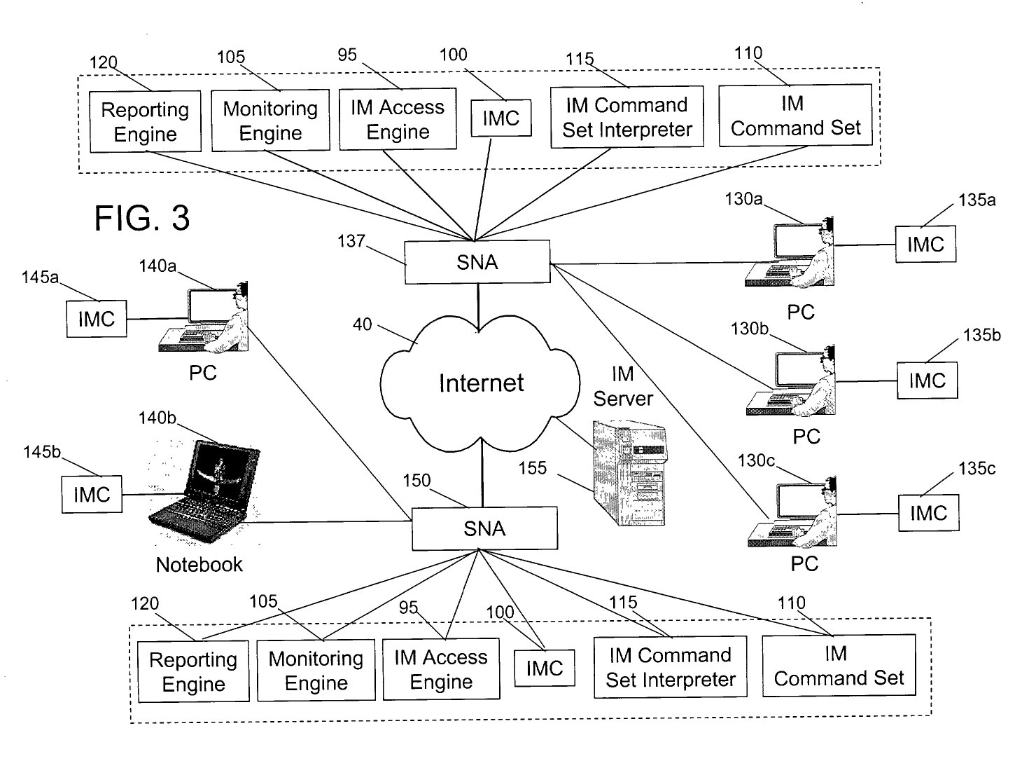

Referring now to FIG. 3, a schematic diagram of another exemplary embodiment of the network environment in which the present invention operates is described. In this embodiment, a controlling user of a local area network including appliances 130a-c and connected to Internet 40 through SNA 137 wants to monitor network activity of a local area network including appliances 140a-b connected to Internet 40 through SNA 150. Both SNA 137 and SNA 150 include a network gateway. To do that, SNAs 137 and 150 are equipped with modules 95-120, including IMC 100, that enable SNAs 137 and 150 to be buddies on an IM service network operated through IM server 155. Modules 95-120 also enable SNAs 137 and 150 to find their respective dynamic IP addresses on the fly.

SNA 150 sends messages to SNA 137 using IMC 100 to inform SNA 137 of any local area network activity of appliances 140a-b. SNA 137 then forwards the messages to the controlling user, who then directs SNA 150 to act upon users of appliances 140a-b by means of a message to SNA 150 through SNA 137. The message includes one or more commands from IM command set 110, such as a command to disconnect user of appliance 140a from Internet 40.

It should be understood by one skilled in the art that IMCs 135a-c and IMCs 140a-b may be the same client or they may be different IM clients connected to different IM servers, in which case SNAs 137 and 150 may have an IM client for each different IM service and/or an IM plug-in that enables SNAs 137 and 150 to connect to the different IM servers. It should also be understood by one skilled in the art that a controlling user connected to Internet 40 through SNA 137 may monitor network activity of appliances 140a-b connected to Internet 40 through SNA 150, or any other local area network connected to Internet 40 through a SNA that is a buddy of gateway 150 on an IM service network.

Furthermore, it should be understood by one skilled in the art that modules 95-120 may be embedded in an analog modem, and a controlling user connected to the analog modem may monitor network activity of another user connected to Internet 40 through another analog modem having modules 95-120 to make it a buddy of the modem used by the controlling user.

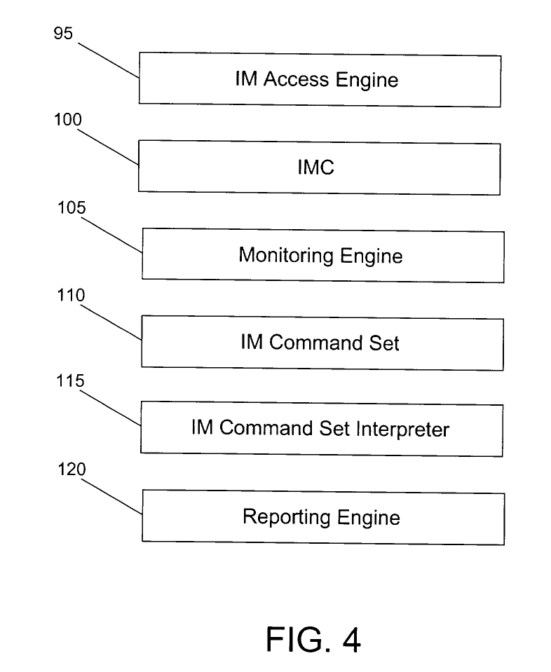

Referring now to FIG. 4, a schematic diagram of the components used in a preferred embodiment of the present invention is described. The components include: (1) IM access engine 95; (2) IMC 100; (3) monitoring engine 105; (4) IM command set 110; (5) IM command set interpreter 115; and (6) reporting engine 120. The components are embedded into a SNA such as SNAs 90, 125, 137 and 150, for controlling the SNA or monitoring and controlling network activity in case the SNA includes a network gateway, communicating the monitored activity to a controlling user using IM, and responding to commands from the controlling user to control the monitored activity.

IM access engine 95 launches IMC 100 to connect to an IM server maintained by an IM service provider. IMC 100 is a standard IM client for sending/receiving instant messages to/from another IM client connected to the IM server. Once IMC 100 is connected to the IM server, IM access engine 95 logs the SNA onto the IM server with its own screen name and password specified by a controlling user upon the SNA's configuration. The screen name and password may be changed at any time and, preferably, are known only to the controlling users authorized to control the SNA.

The IM server maintains a contact list or “buddy list” for the SNA to allow the SNA to send an instant message to any one in his/her buddy list, as long as that subscriber, commonly referred to as a “buddy”, is also online. The IM server may be any IM server used by an IM service, such as ICQ, AOL Instant Messenger (“AIM”), provided by America Online, Inc., of Dulles, Va., Yahoo! Messenger, provided by Yahoo!, Inc., of Sunnyvale, Calif., and MSN Messenger, provided by Microsoft Corporation, of Redmond, Wash., among others.

IMC 100 is a program for making requests to the IM server, which fulfills the requests. By launching IMC 100, the SNA can send instant messages to any user on its buddy list. The controlling users in the SNA's buddy list may be using the same IMC as the SNA, that is, the users and the SNA may be buddies in the same IM service network, or they may be using different IMCs, in which case the SNA may have an IMC for each IM service used by its buddies, or it may have a single universal IMC and/or an IM plug-in that enables the SNA to connect to multiple IM services. A controlling user may be an individual with access to a network appliance with IMC 100, a server with IMC 100, or another smart network appliance configured with IMC 100 and able to send/receive instant messages to/from other smart network appliances or individuals without user intervention.

Once the SNA is logged onto an IM server, the IM server sends connection information of each controlling user in the SNA's buddy list to the SNA. If the IM server finds any of the SNA's buddies logged onto the IM server, IMC 100 is notified so the SNA may send messages to its buddies who are logged onto the IM server. The messages sent by the SNA contain information detailing its activity or the activity of other network appliances connected to it, or in case the SNA includes a network gateway, information detailing the activity of each user in the local area network supported by the network gateway, such as web sites visited, chat rooms entered and the contents of the messages exchanged in the chat room, image files viewed, and so on.

The SNA collects activity information through monitoring engine 110. Monitoring engine 110 is a program capable of collecting status information regarding the operation of the SNA and may include a packet sniffer for reading the contents of each network packet transmitted from or to the network through the SNA. The information collected by monitoring engine 110 is transmitted by the SNA to each one of its buddies that are online using IMC 100. IMC 100 sends the information directly to the IMCs of the SNA's buddies, without having to communicate to the IM server.

After receiving a message from the SNA, a controlling user may direct the SNA to perform an action based on the information collected by monitoring engine 110 and transmitted to the controlling user, such as directing the SNA to start an operation, or in case the SNA includes a network gateway, blocking a user from visiting a given web site, entering a particular chat room, limiting the time a user may stay online, and so on. The controlling user directs the SNA to perform an action by using a command in IM command set 110 embedded in the SNA.

IM command set 110 has a list of commands that a controlling user may use to direct the SNA to perform an action, such as a “block” command to block a user from visiting a web site or chat room, a “disconnect” command to disconnect a user from Internet 40, and a “time out” command to time out an SNA operation, among others. IM command set interpreter 115 is provided in the SNA for it to understand each message received through IMC 100 and execute the command included in the message.

It should be understood by one skilled in the art that the commands included in IM command set 110 may be listed on web pages associated to a web server included in the SNA, a web site associated with the manufacturer of the SNA, accessed through a graphical user interface on the appliance used by the controlling user to control the SNA, accessed by a telephone line, or available through any other means, such as a hardcopy of commands as part of a manual or operating instructions associated to the SNA.

The SNA also includes reporting engine 120 for recording activity information into logs and sending the logs to a controlling user. The logs may be transmitted to the controlling users via IM when the controlling users are online, posted on a secure web site accessed only by the controlling user with a security key, or transmitted by other means, such as via electronic mail, voice mail, among others.

It should be understood by one skilled in the art that other components may be embedded into the SNA for purposes of monitoring its activity or the activity of a local area network in case the SNA includes a network gateway, controlling its operation, and communicating the monitored activity to controlling users. It should also be understood by one skilled in the art that other components may be installed on an appliance used by the controlling user to control the activity of a SNA.

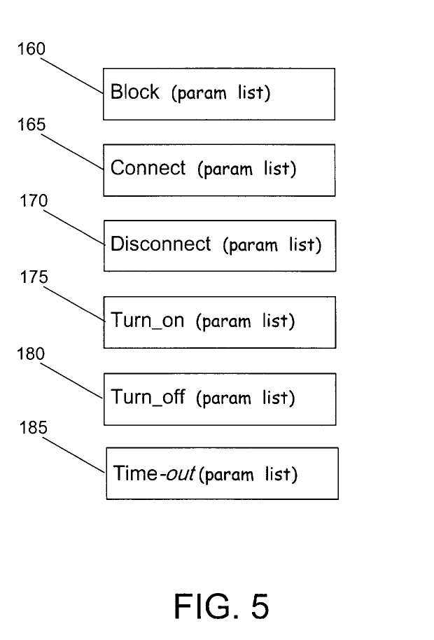

Referring now to FIG. 5, an illustrative diagram of a list of commands in the command set is described. Each command in IM command set 110 has a command name and a list of parameters corresponding to the command. Block command 160 is a command for blocking a user from visiting a web site, chat room, or newsgroup, or from viewing an image or audio file. Block command 160 has a parameter list to specify the user and the activity to be blocked. Connect command 165 is a command for connecting a user to a network possibly after having disconnected the user from the network with disconnect command 170. Similar to block command 160, connect command 165 and disconnect command 170 have a parameter list to specify the user or the network appliance to be connected or disconnected.

Turning-on command 175 and turning-off command 180 are used to turn an operation of the SNA on or off, or, in case the SNA includes a network gateway, to turn a network appliance connected to the SNA on or off. The parameter list associated with these commands may include a time period during which the SNA operation or the network appliance connected to the SNA is to be on/off. IM command set 110 may also have command 185 to time-out a SNA operation, or in case the SNA includes a network gateway, to time-out a user from using Internet 40 or from using a web browser, IM, or other application. The parameter list associated with time-out command 195 may include the user and the application to be timed-out, among other parameters.

It should be understood by one skilled in the art that IM command set 110 may include different or additional commands not shown in FIG. 5. It should also be understood by one skilled in the art that modules 95-120 may be used by a SNA to find the dynamic IP address of another SNA configured with modules 95-120, without user intervention.

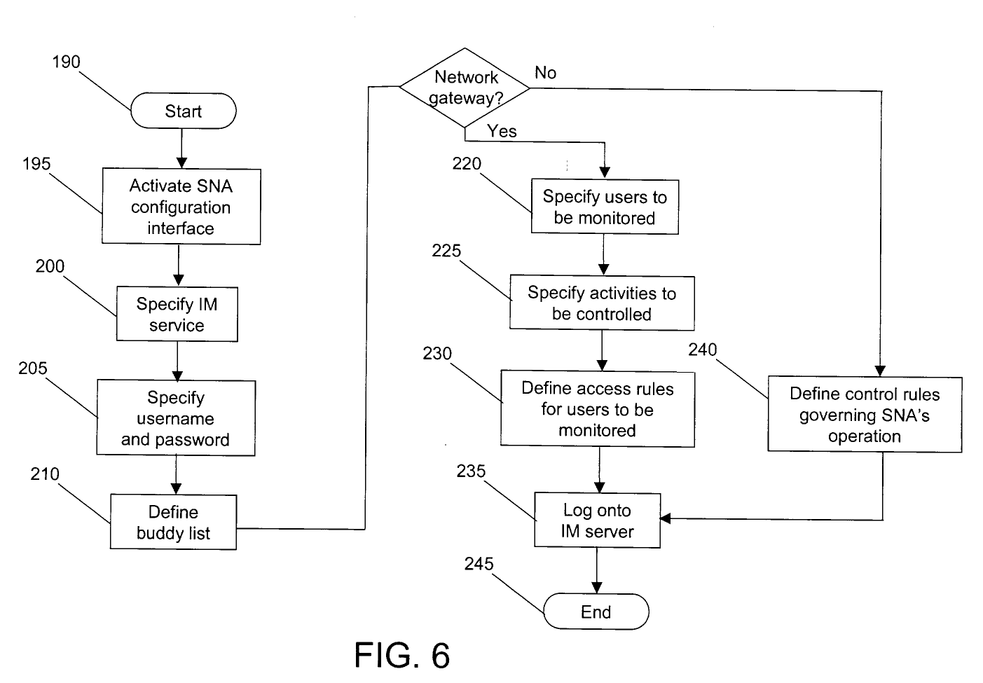

Referring now to FIG. 6, a flow chart for configuring a smart network appliance to act as an IM client is described. The SNA is configured by a controlling user by means of a SNA configuration interface (195). The SNA configuration interface may be accessed by the controlling user on any network appliance, when the SNA is first installed in the network, or at a later time. The SNA configuration interface may be a web page associated to a web server included in the SNA, an interface that is part of the operating system of the network appliance used by the controlling user to configure the SNA, part of a web site maintained by the SNA manufacturer, or another interface that may be used by the controlling user to configure the SNA for establishing its IP address and other SNA configuration parameters.

At step 200, the controlling user specifies the IM service to be used when communicating to the SNA. The IM service must be one for which the SNA has a corresponding IMC installed. The IM services that may be used by the controlling user for communicating with the SNA are preferably listed in the SNA configuration interface. At step 205, the controlling user specifies a screen name and a password for the SNA to be identified as a subscriber to the IM service used by the controlling user and the SNA to communicate with each other. The controlling user defines the SNA's buddy list at step 210. The buddy list may have more than one controlling user, which may be an individual with access to a network appliance with an IMC, a server with an IMC, or another smart network appliance configured with an IMC and able to send/receive instant messages to/from other smart network appliances or individuals without user intervention.

In case the SNA includes a network gateway (215), the controlling user may specify the users that are to be monitored in the network controlled by the SNA at step 220. Otherwise, the controlling user specifies control rules for governing the operation of the SNA at step 240. The users may be specified by their screen names on a given IM service, electronic mail service, or other applications. Alternatively, the controlling user may specify the IP addresses of the network appliances to be monitored.

At step 225, the user may specify the activities to be controlled by the SNA. For example, the controlling user may specify that only web sites and IM exchanges between users on the network are to be monitored. Additionally, the controlling user may define access rules for the users and activities to be monitored at step 230. The access rules are defined with commands in IM command set 110. For example, the controlling user may use the block command to specify URLs to be blocked by the SNA.

Lastly, at step 235, the SNA executes IM access engine 95 to launch IMC 100 to log onto the IM server corresponding to IMC 100. The SNA then begins to control its activities and, in case the SNA includes a network gateway, the activities of a local area network supported by it by using monitoring engine 105.

It should be understood by one skilled in the art that additional steps not shown in FIG. 6 may be used to configure the network gateway to act as an IM client.

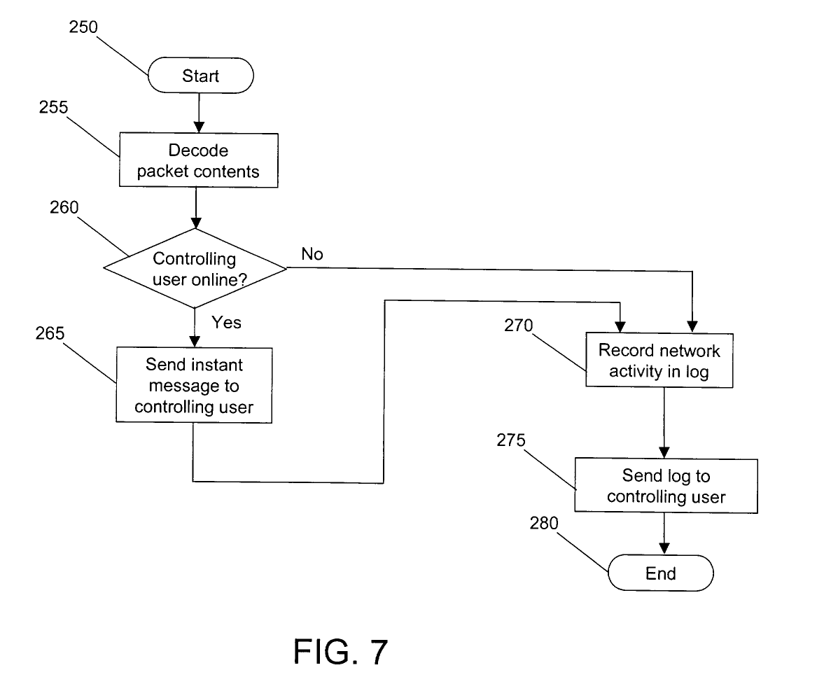

Referring now to FIG. 7, a flow chart for monitoring network activity and communicating the monitored activity to a controlling user is described. At step 255, the SNA runs monitoring engine 105 to decode the contents of packets coming from/to a particular user or appliance to be monitored. If the controlling user is online (260), the SNA sends an instant message using IMC 100 to the controlling user at step 265 to communicate the monitored activity to the controlling user.

In case the controlling user is not online, the SNA updates its network activity log with reporting engine 120 to record the network activity monitored (270). The network activity log may be sent to the controlling user using IMC 100 when the controlling user is online, or it may be sent using electronic mail, voice mail, or any other message (275). The network activity log may also be posted on a secure web site accessed only by the controlling users authorized to monitor the network.

It should be understood by one skilled in the art that additional steps not shown in FIG. 7 may be used by the network gateway to monitor network gateway and communicate the monitored activity to a controlling user.

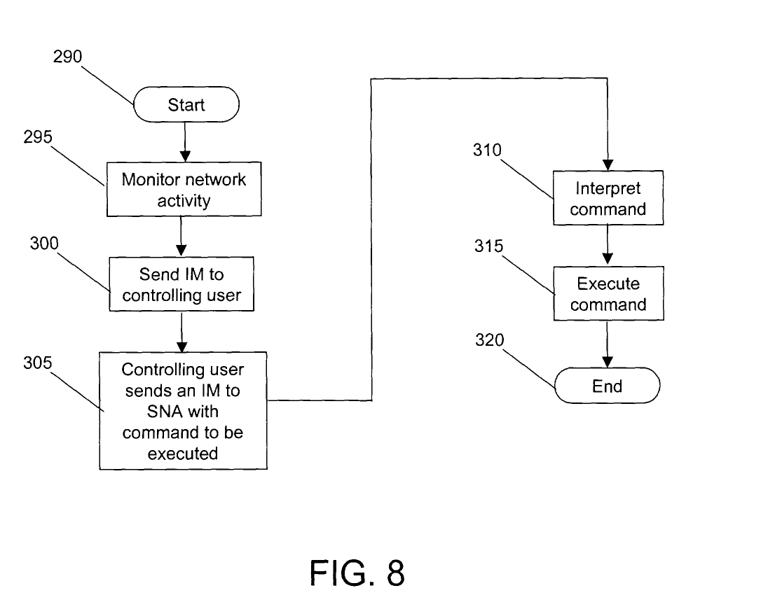

Referring now to FIG. 8, a flow chart for performing an action based on monitored activity is described. First, the SNA monitors its activity or, in case it includes a network gateway, the activity of the network (295) and communicates the monitored information to the controlling user (300) using the steps described above with reference to FIG. 7. Second, the controlling user sends an instant message to the SNA containing a command to be executed (305). Lastly, the command is interpreted (310) and executed (315) by the SNA using IM command interpreter 115. For example, the SNA may block a user from accessing a web site, or may interrupt the user's Internet connection for a limited period of time.

It should be understood by one skilled in the art that the additional steps not shown in FIG. 8 may be used by the network gateway to perform an action in the network based on monitored network activity.

Although particular embodiments of the present invention have been described above in detail, it will be understood that this description is merely for purposes of illustration. Specific features of the invention are shown in some drawings and not in others, and this is for convenience only and any feature may be combined with another in accordance with the invention. Steps of the described processes may be reordered or combined, and other steps may be included. Further variations will be apparent to one skilled in the art in light of this disclosure and are intended to fall within the scope of the appended claims.

What is claimed is:

1. A smart network appliance, comprising an instant messaging client routine in the smart network appliance for sending and receiving an instant message without user intervention.

2. The smart network appliance of claim 1, wherein the instant message is sent to and received from one or more of: a controlling user; a server; and a second smart network appliance.

3. The smart network appliance of claim 1, further comprising a software routine in the instant messaging client routine configured to receive an instant message from the controlling user via a remote network appliance.

4. The smart network appliance of claim 1, wherein the instant message comprises a command to order the smart network appliance to perform an action.

5. The smart network appliance of claim 4, further comprising an interpreter routine for interpreting and executing the command.

6. The smart network appliance of claim 1, further comprising a software routine for monitoring and controlling network activity.

7. The smart network appliance of claim 1, further comprising a software routine for monitoring and controlling an operation of the smart network appliance.

8. The smart network appliance of claim 1, further comprising a software routine for monitoring and controlling an operation of a network appliance connected to the smart network appliance.

9. The smart network appliance of claim 1, wherein the smart network appliance comprises one or more of: an embedded electronic device; a personal computer; a network gateway; a portable computer; an electronic organizer; a personal digital assistant; a wireless telephone; an entertainment system; a stereo system; a video game unit; and a household appliance.

10. The smart network appliance of claim 9, wherein the network gateway comprises one or more of: a dial-up modem; a high-speed modem; a router; a network switch; a network hub; and a network bridge.

11. The smart network appliance of claim 1, further comprising an instant messaging access routine in the smart network appliance for launching the instant messaging client routine.

12. The smart network appliance of claim 1, further comprising a buddy list associated to the smart network appliance.

13. The smart network appliance of claim 12, wherein the buddy list comprises one or more of: the controlling user; the server; and the second smart network appliance.

14. The smart network appliance of claim 1, further comprising a command set embedded in the smart network appliance.

15. The smart network appliance of claim 14, wherein the command set comprises a plurality of commands comprising one or more of: a block command; a connect command; a disconnect command; a turn-on command; a turn-off command; a reset command; and a time-out command.

16. The smart network appliance of claim 1, further comprising:
a reporting routine for recording network activity into a log; and
a routine for transmitting the log to a buddy in the buddy list associated to the smart network appliance.

17. The smart network appliance of claim 2, wherein the server comprises:
an instant messaging client routine;
a routine for converting an instant message sent by the smart network appliance into an off-line message for the controlling user; and
a routine for storing the instant message in a database associated with the server.

18. The smart network appliance of claim 17, wherein the off-line message comprises one or more of: an electronic mail; a web page; a telephone call; a voice mail; and a fax.

19. The smart network appliance of claim 6, wherein the software routine for monitoring network activity comprises a packet sniffer routine.

20. The smart network appliance of claim 1, wherein the instant messaging client routine further comprises a routine for determining the IP address of a buddy in the buddy list of the smart network appliance.

21. A method of operating a smart network appliance, the method comprising:
providing a network appliance having an instant messaging routine; and
executing the instant messaging routine without user intervention.

22. The method of claim 21, wherein executing the instant messaging routine comprises sending an instant message to and receiving an instant message from one or more of: a controlling user; a server; and a second smart network appliance.

23. The method of claim 21, further comprising interpreting and executing a command in the instant message.

24. The method of claim 21, wherein executing an instant messaging routine in the smart network appliance further comprises launching the instant messaging routine.

25. The method of claim 24, wherein launching the instant messaging routine comprises logging the smart network appliance into an instant messaging server as a subscriber of an instant messaging service.

26. The method of claim 21, further comprising specifying a buddy list associated to the smart network appliance.

27. The method of claim 26, wherein specifying a buddy list associated to the smart network appliance comprises identifying a plurality of buddies in the buddy list, the plurality of buddies comprising one or more of: the controlling user; the server; and the second smart network appliance.

28. The method of claim 21, further comprising:
monitoring and controlling network activity;
monitoring and controlling the operation of the smart network appliance; and
monitoring and controlling a network appliance connected to the smart network appliance.

29. A method for determining an IP address of a first network appliance, the method comprising:
executing an instant messaging routine in the first network appliance, without user intervention;
executing an instant messaging routine in a second network appliance, without user intervention; and
including the first network appliance in a buddy list associated with the second network appliance.

30. The method of claim 29, wherein executing an instant messaging routine in the first network appliance comprises providing an instant messaging access routine in the first network appliance for launching the instant messaging routine in the first network appliance.

31. The method of claim 29, wherein executing an instant messaging routine in the second network appliance comprises providing an instant messaging access routine in the second network appliance for launching the instant messaging routine in the second network appliance.

32. The method of claim 31, wherein launching the instant messaging routine comprises logging the first network appliance into an instant messaging server as a subscriber of an instant messaging service.

33. The method of claim 29, wherein executing an instant messaging routine in the first network appliance comprises:
sending an instant message to the second network appliance; and
receiving an instant message from the second network appliance.

34. The method of claim 29, wherein the one of the first or second network appliances comprises one or more of: an embedded electronic device; a personal computer; a network gateway; a portable computer; an electronic organizer; a personal digital assistant; a wireless telephone; an entertainment system; a stereo system; a video game unit; and a household appliance.

35. The method of claim 29, further comprising determining an IP address of the second network appliance.
